(19) United States
(12) Patent Application Publication
(10) Pub. No.: US 2017/0133760 A1
(43) Pub. Date: May 11, 2017

(54) VEHICULAR ANTENNA SYSTEM AND VEHICLE

(71) Applicant: Leauto Intelligent Technology (BEIJING) Co. Ltd., Beijing (CN)

(72) Inventors: Zhong WANG, Beijing (CN); Taiwei SONG, Beijing (CN); Chao WU, Beijing (CN)

(21) Appl. No.: 14/970,285

(22) Filed: Dec. 15, 2015

(30) Foreign Application Priority Data
Nov. 11, 2015 (CN) 201510767881.4

(51) Int. Cl. H01Q 5/50; H01Q 1/32; H01Q 5/10

(52) U.S. Cl. CPC H01Q 5/50; H01Q 5/10; H01Q 1/3291

(57) ABSTRACT

A vehicular antenna system is disclosed. The vehicular includes a central control unit and a plurality of Long Term Evolution (LTE) modules, wherein each of the LTE modules includes an LTE component and at least one antenna components; the LTE component is connected with the at least one antenna component; and the central control unit is connected with each of the LTE modules.

### CROSS-REFERENCE TO RELATED APPLICATIONS

This application claims priority to Chinese patent application No. 201510767881.4 filed on Nov. 11, 2015 and titled “VEHICULAR ANTENNA SYSTEM”, the content of which is incorporated herein by reference in its entirety.

### FIELD OF TECHNOLOGY

The present disclosure relates to the field of communications and particularly to a vehicular antenna system and vehicle.

### BACKGROUND

Along with the social development, there are a constantly growing level of people's life, and also constantly growing functions and comforts of vehicles as required by people for whom it is desirable to watch videos, to access the Internet at a high speed, and to enable various other Internet related functions in their vehicles, so intelligent vehicles over the Internet will inevitably emerge in the future.

The vehicles can perform these functions only if they receive radio signals through vehicular antennas, so there are an increasing number of required antennas along with emerging functions of the vehicles, e.g., radio, global positioning, mobile TV, mobile communication, and other antennas, but the vehicles are generally provided with single antennas in the prior art, and as can be apparent, the vehicles can not receive the various signals, so their users can not watch videos, access the Internet at a high speed, and enable various other Internet related functions in their vehicles.

### SUMMARY

An embodiment of the disclosure provides a vehicular antenna system including a central control unit and a plurality of Long Term Evolution (LTE) modules, wherein:

each of the LTE modules includes an LTE component and at least one antenna component;

the LTE component is connected with the at least one antenna component; and

the central control unit is connected with each of the LTE modules.

Correspondingly an embodiment of the disclosure further provides a vehicular including the vehicular antenna system.

### BRIEF DESCRIPTION OF THE DRAWINGS

In order to make the technical solutions in the embodiments of the disclosure or in the prior art more apparent, the drawings to which the embodiments or the prior art are described with reference will be briefly introduced below, and apparently the drawings to be described below are merely illustrative of some of the embodiments of the disclosure, and those ordinarily skilled in the art can derive from these drawings other drawings without any inventive effort. In the drawings:

FIG. 1 illustrates a schematic structural diagram of a vehicular antenna system according to an embodiment of the disclosure;

FIG. 2A to FIG. 2D illustrate schematic structural diagrams of an antenna component according to embodiments of the disclosure;

FIG. 3 illustrates a schematic structural diagram of an LTE module according to an embodiment of the disclosure;

FIG. 4 illustrates a schematic diagram of a positioned LTE module according to an embodiment of the disclosure;

FIG. 5 illustrates a schematic diagram of a positioned LTE module according to an embodiment of the disclosure;

FIG. 6 illustrates a schematic structural diagram of a vehicular antenna system according to an embodiment of the disclosure; and

FIG. 7 illustrates a schematic structural diagram of a vehicular antenna system according to an embodiment of the disclosure.

### DETAILED DESCRIPTION OF THE EMBODIMENTS

In order to make the objects, the technical solutions and the advantages of the embodiments of the disclosure more apparent, the disclosure will be further described in details with reference to the drawings. Apparently the described embodiments are only a part but all of the embodiments of the disclosure. Based upon the embodiments of the disclosure here, all of other embodiments derived by those ordinarily skilled in the art without any inventive effort shall come into the scope of the disclosure.

At present, a traditional vehicular antenna system is designed only with Frequency Modulation, Global Positioning System (GPS), Wireless-Fidelity/Bluetooth (WiFi/BT), China Mobile Multimedia Broadcast (CMMB), and other general functions, and the antennas are commonly designed as shark fin antennas, helical antennas, column antennas, etc. Along with the technical development, users desire to perform vehicular video communication, watch high-definition videos, and perform other similar activities through a vehicular center console, where these functions can be performed only if their vehicles can transmit at a high speed over the Internet.

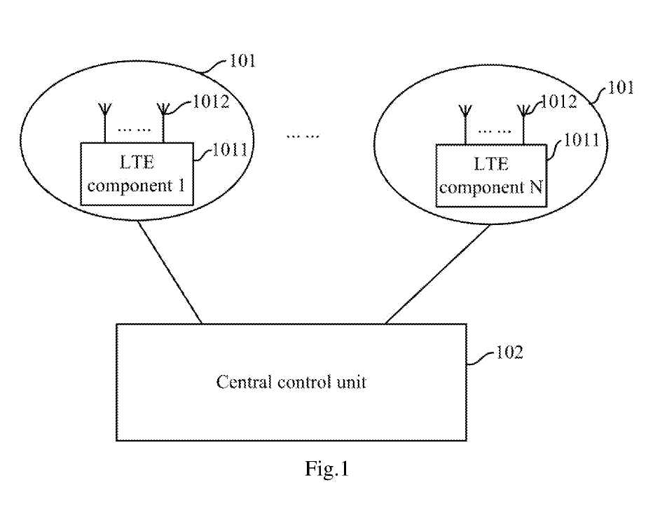

Following the description above, FIG. 1 illustrates a schematic structural diagram of a vehicular antenna system, as illustrated in FIG. 1, which includes:

A central control unit 102, and a plurality of LTE modules 101, each of the LTE modules includes an LTE component 1011 and at least one antenna component 1012, the LTE component 1011 is connected with the at least one antenna component 1012, and the central control unit 102 is connected with each of the LTE modules 101.

The LTE components 1011 in the LTE modules 101 can perform second generation (2G), third generation (3G), and fourth generation (4G) communication, and the LTE components 1011 can receive and transmit signals through their corresponding antenna components 1012 to communicate with the outer network.

As illustrated in FIG. 1, each of the plurality of LTE modules 101 includes one LTE component 1011 connected with two antenna components 1012. The LTE component 1011 can alternatively be connected with one antenna component 1012, although there may be better communication performance of the LTE component 1011 if there are a larger number of antenna components 1012 connected therewith.

If there is only one LTE module 101, then the vehicular antenna system may have a higher network transmission speed than in the 2G mode and the 3G mode. If there are a plurality of LTE modules 101, then a vehicle can be provided with high-speed network transmission through the plurality of LTE modules 101 in the vehicular antenna system due to aggregation of a plurality of carriers to thereby enable vehicular video communication, watch high-definition videos, and perform other similar activities in the vehicle. The embodiment of the disclosure can improve the network transmission speed over the prior art.

The LTE component 1011 can be arranged on a Printed Circuit Board (PCB), where the LTE component 1011 can be integrated on the PCB, and antenna feed pins of the antenna components 1012 can be pressed on antenna feed points on the PCB, and then the antenna components 1012 can be electrically connected with their corresponding LTE component 1011 through wirings on the PCB.

The antenna component 1012 in the embodiment of the disclosure can be fabricated in a number of process including at least the following several processes:

First Scheme

The antenna component 1012 is fixed on an antenna bracket of the PCB, where the antenna component 1012 is supported by the antenna bracket fixed on the PCB, so that the antenna feed pins of the antenna component 1012 can be pressed on the antenna feed points of the PCB.

Second Scheme

The antenna component 1012 is formed by etching a Flexible Printed Circuit (FPC). The FPC, which is covered by a mask with the antenna pattern, is exposed, and then a metal layer on the exposed FPC is etched, thus the antenna component 1012 in the form of a labyrinth is formed. The antenna component 1012 fabricated in the FPC process is compact in structure and convenient to install, and the FPC can be affixed on the casing of a structure through a back-adhesive, e.g., on the outer casing of the LTE module 101, possibly on the outside or the inside of non-metal portion of the outer casing of the module, or on the surface of non-metal casing, or the FPC can be affixed on the PCB. The antenna component 1012 fabricated this way has the advantage of a high wiring density, a low weight, high bendability, etc.

Third Scheme

The antenna component 1012 is formed on the casing of a structure piece by laser carving with Laser Direct Structuring (LDS) process. Metal powers are laser carved onto the casing of any structure piece in an LDS process, e.g., on the outer casing of the LTE module 101, possibly on the outside or the inside of non-metal portion of the outer casing of the module, or on the surface of non-metal casing. The antenna component 1012 fabricated in this way can be designed with any antenna pattern and formed by laser carving on the casing of a structural piece in any shape flexibly without being restricted by the structural modality of a product, and can be prevented from being interfered by metal in the LTE module 101, and also the volume of the LTE module 101 can be lowered.

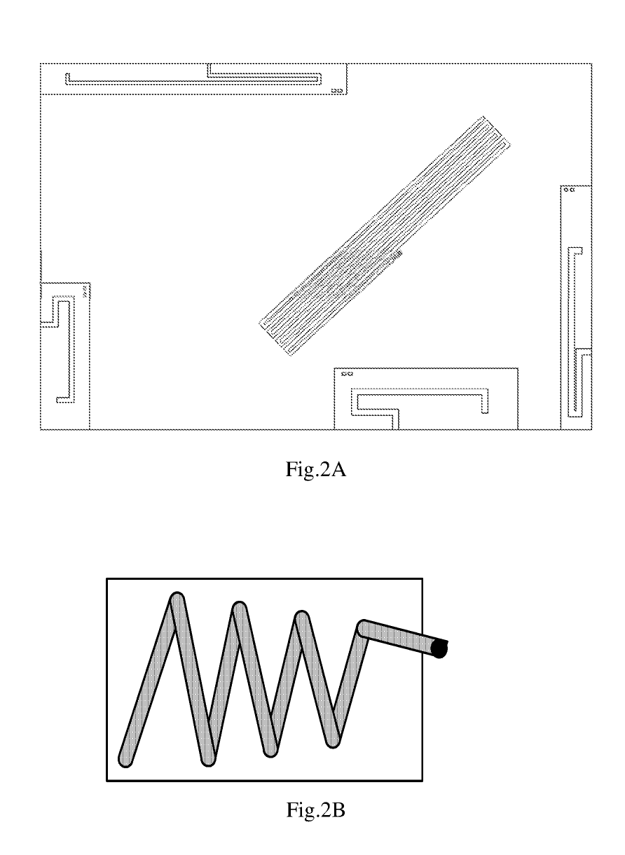

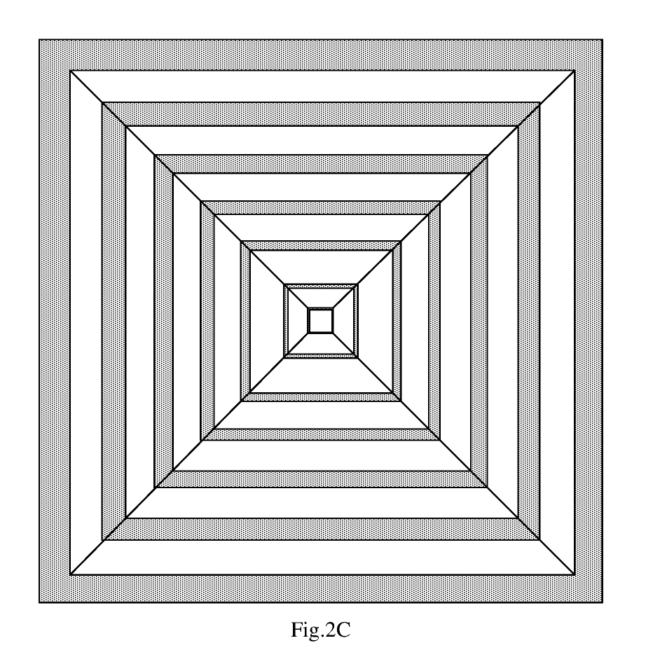

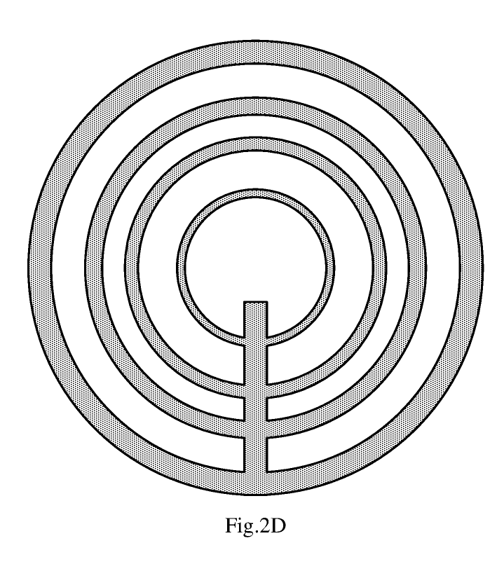

Correspondingly, embodiments of the disclosure further provide schematic structural diagrams of several antenna components 1012 as illustrated in FIG. 2A to FIG. 2D. FIG. 2A illustrates a sectional view of an antenna component 1012, i.e., a cross section view of the antenna component 1012. As can be apparent from FIG. 2A, the pattern structure of the antenna component 1012 is printed on an FPC. FIG. 2B illustrates an antenna component 1012 fabricated from an FPC, where the black dot represents an antenna feed pin. FIG. 2C and FIG. 2D illustrate two antenna patterns of antenna components 1012, which are an annular structure and a “ [symbol] ”-shaped structure respectively. The antenna component 1012 can be fabricated in either of these two patterns, where the FPC is etched in the pattern, thus forming the antenna component 1012, or metal powers are laser carved through LDS to form either of the patterns. The pattern of the antenna component 1012 can be designed freely in a practical application.

The three schemes above in which the antenna component 1012 is fabricated have been described in the embodiments of the disclosure only as examples, but the process in which the antenna components 1012 are fabricated will not be limited to these schemes, so the embodiments of the disclosure will not be limited thereto.

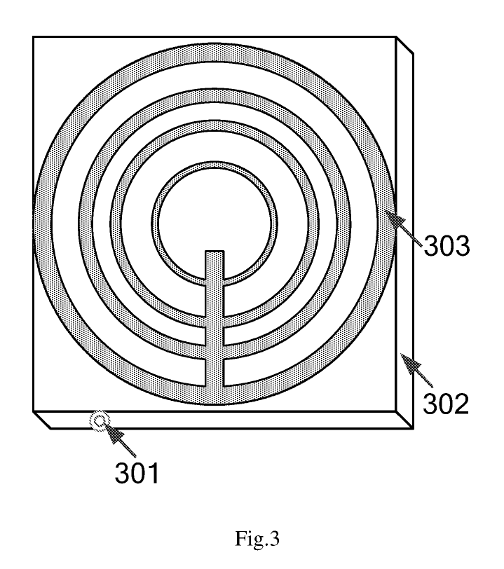

Each of the LTE modules in the embodiments of the disclosure can be designed into a separate modular box. FIG. 3 illustrates a schematic diagram of a structured LTE module 101. As illustrated in FIG. 3, the antenna component 1012 is formed on the top of the box by laser carving with LDS, for example, the antenna pattern 303. The LTE component 1011 in the LTE module 101 can communicate with the central control unit 102 through a bundle of USB lines. Each box includes a box body 302, and a reserved USB interface 301, where the USB interface can be compatible with a number of USB versions, although the embodiment of the disclosure is used with the USB Version 3.0; and the LTE module 101 communicates with and is powered by the central control unit 102 through a bundle of USB 3.0 lines. The modular box further includes primary and secondary antennas of the LTE component 1011 to transmit and receive signal. The antennas can be designed as directional antennas with a radiation angle being less than or equal to 180°, so that really designed radiation surfaces of the antennas can be positioned as a function of surroundings of different positions where they are installed.

The appearance of each of the boxes can be designed for a real application but will not be limited to the cuboid. Also the antenna components 1012 can be formed by laser carving on the four sides of the modular box in a real application, where the antennas are designed as directional antennas, and the radiation faces of the antenna components 1012 can be designed as a function of the varying positions where they are installed. In one embodiment of the disclosure, the antenna components 1012 are arranged on the face of the modular box facing passengers, that is, the antenna components 1012 are formed on the top of the modular box by laser carving or arranged on the four sides of the modular box.

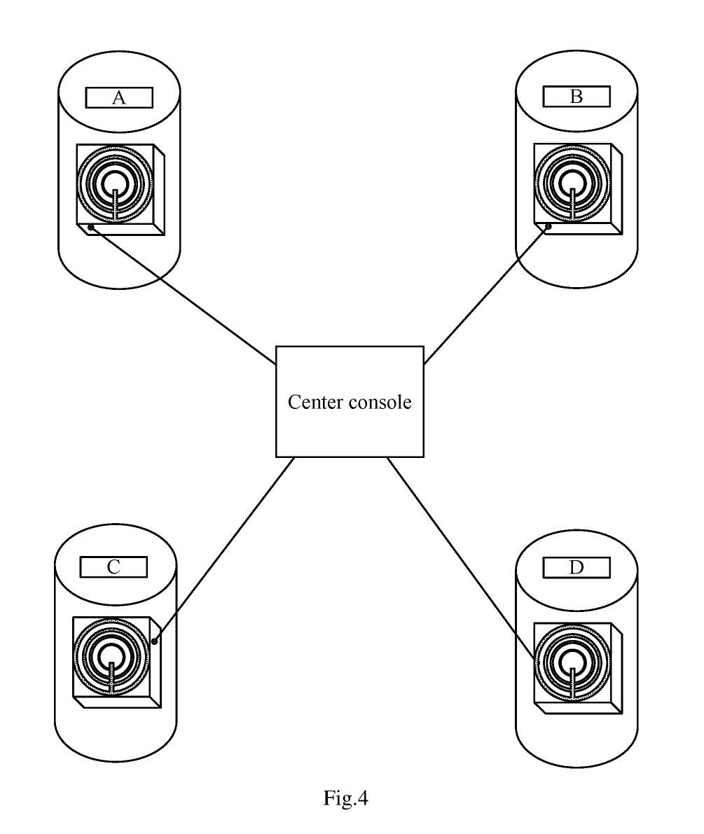

For better high-speed communication of the vehicular antenna system, a plurality of LTE modules 101 can be stalled on different positions of the vehicle. As illustrated in FIG. 4, the LTE modules 101 can be positioned so that they are installed in a column A, a column B, a column C, or a column D of the vehicle, and they can be connected with the central control unit 102 of the center console of the vehicle through a USB bus to communicate with the central control unit 102.

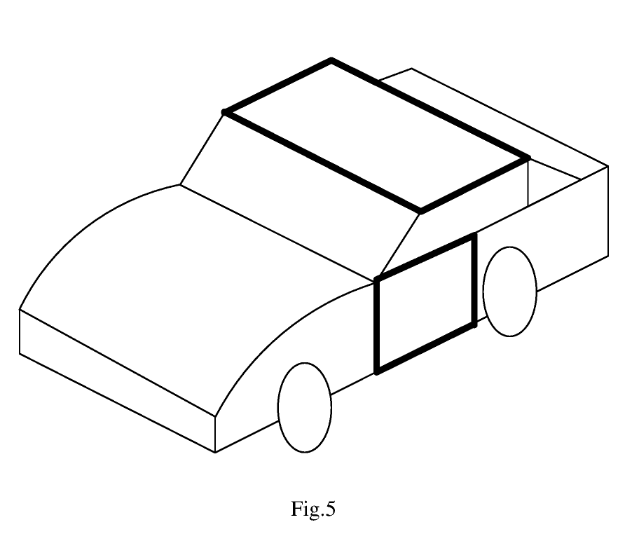

In an embodiment of the disclosure, the LTE modules 101 can alternatively be positioned on any one or more of the outside of the roof of the vehicle, the inside of the door of the vehicle, a platform at the bottom of the front windshield of the vehicle, a platform at the bottom of the rear windshield of the vehicle or the rearview mirror of the vehicle. If there are a large number of LTE modules 101 required for the vehicle, then more than one of them can be co-located, and there will be a higher quality of high-speed communication if there are a large number of LTE modules 101 in use. As illustrated in FIG. 5, the LTE modules 101 can be installed on the outside of the roof of the vehicle, and the inner side of the door of the vehicle, in the zones delimited by the bold lines in black in FIG. 5.

FIG. 1 illustrates N LTE modules 101, all of which are connected with the central control unit 102, where if there are a larger number of LTE modules 101 connected with the central control unit 102, then there will be better performance, and possible high-speed communication, e.g., at 10 Gb/s, 20 Gb/s, etc., of the vehicular antenna system. Signals received by the LTE modules 101 are transmitted to the central control unit 102 for processing.

In an embodiment of the disclosure, the central control unit 102 is connected with each of the LTE modules 101 through a Universal Serial Bus (USB) bus. Both the central control unit 102 and the LTE modules 101 are provided with USB interfaces, where the USB interfaces of the central control unit 102 and the LTE modules 101 are connected respectively by the USB bus.

Since antenna systems of vehicles in the prior art are designed with single antenna, the vehicles can receive various signals only if a plurality of antennas are installed on the vehicles, but these antennas have to be installed on the outsides of the roofs of the vehicles, thus increasing the instability of the vehicles. Unlike the prior art, the LTE components 1011 and the antenna components 1012 are integrated in the LTE modules 101 according to the embodiments of the disclosure, where the LTE modules 101 can be positioned throughout the vehicle instead of being installed on the outside of the roof of the vehicle to thereby improving the stability of the vehicle.

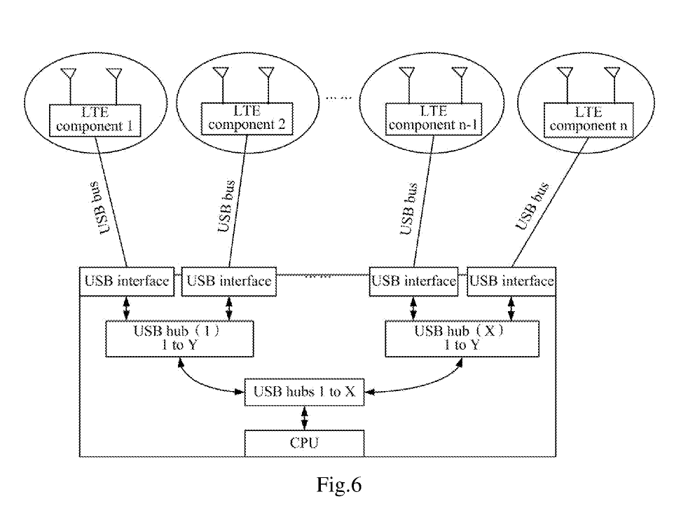

As illustrated in FIG. 6, an embodiment of the disclosure provides a connection scheme of the central control unit 102 with the LTE modules 101. The LTE modules 101 are connected with the USB interfaces in the central control unit 102 through the USB bus, where each of the LTE modules 101 corresponds to one of the USB interfaces. In the central control unit 102, the plurality of USB interfaces are connected with USB hubs, each of the USB hubs can connect Y USB interfaces, where Y is more than or equal to 1, for example, four USB interfaces can be connected with one of the USB hubs. There are X USB hubs, where X is more than or equal to 1, and the X USB hubs are connected onto a single USB hub and connected with a CPU of the central control unit 102 through the single USB hub.

In an embodiment of the disclosure, a larger number of LTE modules 101 can be combined as required for networking, where the LTE modules 101 are distributed throughout the vehicle to thereby lower the difficulty of assembling the vehicular antenna system in order for arbitrary combination. If necessary, then the designed LTE module 101 boxes may be simply connected with the central control unit 102 in the center console. Also as compared with the traditional design, they can communicate concurrently with the central control unit 102 through the USB bus to thereby lower effectively a loss of radio frequency power due to a coaxial line, thus improving the performance of radio frequency, and to alleviate a constraint on the length of the bundle of lines between the LTE modules 101 and the central control unit 102, thus making it more flexible to position the LTE modules 101.

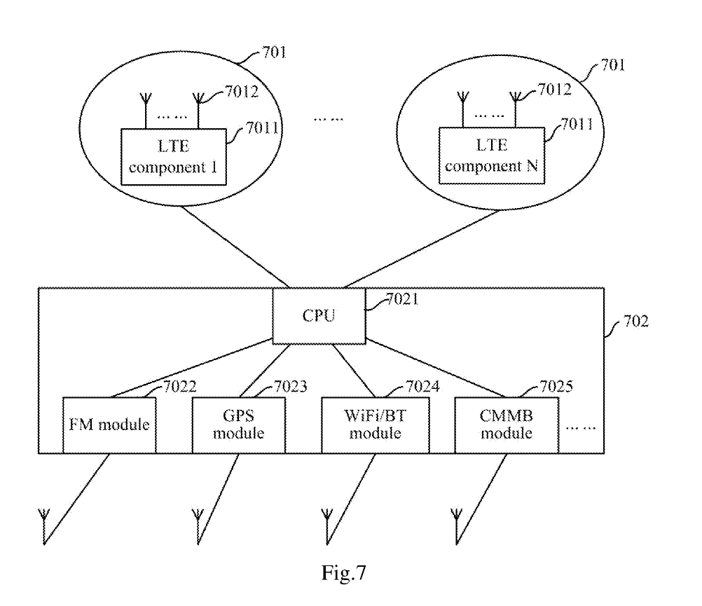

Correspondingly an embodiment of the disclosure further provides a vehicular antenna system, structure thereof as illustrated in FIG. 7. The vehicular antenna system includes a central control unit 702, and a plurality of LTE modules 701, each of which includes an LTE component 7011 and at least one antenna component 7012, where the LTE component 7011 is connected with the at least one antenna component 7012, and the central control unit 702 is connected with each of the LTE modules 701.

A Central Processing Unit (CPU) 7021, an FM module 7022, a GPS module 7023, a WiFi/BT module 7024, and a CMMB module 7025 are arranged on a PCB of the central control unit 702. The vehicular antenna system further includes an FM antenna, a GPS antenna, a WiFi/BT antenna and a CMMB antenna corresponding to the FM module 7022, the GPS module 7023, the WiFi/BT module 7024, and the CMMB module 7025. The FM antenna, the GPS antenna, the WiFi/BT antenna and the CMMB antenna are connected with the central control unit 702 at terminals through coaxial lines.

The central control unit 702 is connected with each of the LTE modules 701 through a Universal Serial Bus (USB) bus. Both the central control unit 702 and the LTE modules 701 are arranged with USB interfaces, where the USB interfaces of the central control unit 702 and the LTE modules 701 are connected respectively by the USB bus. Based upon the same inventive idea, an embodiment of the disclosure further provides a vehicle including the vehicular antenna system above structured particularly as described in the embodiments above, so a repeated description thereof will be omitted here.

Embodiments of the disclosure provide a vehicular antenna system so as to enable high-speed communication through vehicular antennas which are convenient to install and have good stability.

In the embodiment of the disclosure, the plurality of LTE modules can be connected with the central control unit to thereby enable high-speed communication through the antennas of the vehicle. The LTE component can be integrated together with the antenna components so that each of the LTE modules can be installed flexibly to thereby avoid the problem of communication interference arising from the LTE components gathering in the central control unit.

It shall be noted that the embodiments above are only intended to illustrate the technical solutions of the disclosure, but not to limit the disclosure; and although the disclosure has been described in details with reference to the embodiments above, those ordinarily skilled in the art shall appreciate that they still can modify the technical solutions recited in the respective embodiments above or make equivalent substitutions to a part of the technical features thereof; and the essences of the respective technical solutions will not depart from the spirit and scope of the technical solutions in the respective embodiments of the disclosure due to these modifications or substitutions.

1. A vehicular antenna system, comprising a central control unit and a plurality of Long Term Evolution (LTE) modules, wherein:
each of the LTE modules comprises an LTE component and at least one antenna component;
the LTE component is connected with the at least one antenna component; and
the central control unit is connected with each of the LTE modules.

2. The vehicular antenna system according to claim 1, wherein the LTE component is arranged on a Printed Circuit Board (PCB); and
antenna feed pin of the antenna component is pressed on a pad of antenna feed point on the PCB.

3. The vehicular antenna system according to claim 2, wherein the antenna component is fixed on an antenna bracket of the PCB.

4. The vehicular antenna system according to claim 2, wherein the antenna component is formed by etching a flexible printed circuit board, and the antenna component is affixed on a casing of the LTE module.

5. The vehicular antenna system according to claim 2, wherein the antenna component is formed on an outer casing of the LTE module by laser carving with a Laser Direct Structuring (LDS) process.

6. The vehicular antenna system according to claim 1, wherein the central control unit is connected with each of the LTE modules through a USB bus.

7. The vehicular antenna system according to claim 1, wherein the central control unit is located inside a center console of a vehicle, and the LTE modules are located outside the center console of the vehicle.

8. The vehicular antenna system according to claim 7, wherein the LTE modules are located in any one or more of:
a column A of the vehicle, a column B of the vehicle, a column C of the vehicle, or a column D of the vehicle.

9. The vehicular antenna system according to claim 7, wherein the LTE modules are located on any one or more of:
the outside of a roof of the vehicle, the inside of a door of the vehicle, a platform at the bottom of a front windshield of the vehicle, a platform at the bottom of a rear windshield of the vehicle or a rearview mirror of the vehicle.

10. A vehicle, comprising a vehicular antenna system, the vehicular antenna system comprising a central control unit and a plurality of Long Term Evolution (LTE) modules, wherein:
each of the LTE modules comprises an LTE component and at least one antenna component;
the LTE component is connected with the at least one antenna component; and
the central control unit is connected with each of the LTE modules.

11. The vehicle according to claim 10, wherein the LTE component is arranged on a Printed Circuit Board (PCB); and
antenna feed pin of the antenna component is pressed on a pad of antenna feed point on the PCB.

12. The vehicle according to claim 11, wherein the antenna component is fixed on an antenna bracket of the PCB.

13. The vehicle according to claim 11, wherein the antenna component is formed by etching a flexible printed circuit board, and the antenna component is affixed on a casing of the LTE module.

14. The vehicle according to claim 11, wherein the antenna component is formed on an outer casing of the LTE module by laser carving with a Laser Direct Structuring (LDS) process.

15. The vehicle according to claim 10, wherein the central control unit is connected with each of the LTE modules through a USB bus.

16. The vehicle according to claim 10, wherein the central control unit is located inside a center console of the vehicle, and the LTE modules are located outside the center console of the vehicle.

17. The vehicle according to claim 16, wherein the LTE modules are located in any one or more of:
a column A of the vehicle, a column B of the vehicle, a column C of the vehicle, or a column D of the vehicle.

18. The vehicle according to claim 16, wherein the LTE modules are located on any one or more of:
the outside of a roof of the vehicle, the inside of a door of the vehicle, a platform at the bottom of a front windshield of the vehicle, a platform at the bottom of a rear windshield of the vehicle or a rearview mirror of the vehicle.
